(19) United States
(12) Patent Application Publication
(10) Pub. No.: US 2001/0044367 A1
(43) Pub. Date: Nov. 22, 2001

(54) Folder pocket

(76) Inventors: Markus Belmann, Pattonville (DE); Oliver Fritzsch, Freiberg (DE); Andreas Lehnen, Neckar (DE)

Correspondence Address: LERNER AND GREENBERG, P.A., Post Office Box 2480, Hollywood, FL, 33022-2480, US

(21) Appl. No.: 09/859,796

(22) Filed: May 17, 2001

(30) Foreign Application Priority Data
May 17, 2000 (DE) 100 23 933.1

(51) Int. Cl. B31F 1/00

(52) U.S. Cl. 493/417

(57) ABSTRACT

In order to adjust a folding length of a folded sheet running into a folder pocket, a pocket stop extending within the folder pocket, transversely with respect to a sheet running direction, is adjusted by a motor. In order to ensure the exact motorized adjustment of both sides of the pocket stop, the adjustment is carried out with the aid of two threaded spindles. In this case, the threaded spindles are coupled to each other in such a way that a coordinated movement between them is made possible.

### BACKGROUND OF THE INVENTION

Field of the Invention

The invention relates to a folder pocket having a pocket stop that is located within it and is disposed substantially transversely with respect to a paper running direction. The folder pocket further has a drive unit to adjust a position of the pocket stop within the folder pocket.

In order to adjust the folding length of a paper sheet running into a folder pocket, what is known as the pocket stop, on which the paper sheet running in is stopped, extends within the folder pocket, transversely with respect to the sheet running direction. Accordingly, the folding length of the sheet to be folded is determined by the position of the pocket stop. In order to position the pocket stop, the pocket stop of the type mentioned at the beginning is already known from Published, Non-Prosecuted German Patent Application DE 24 27 850 A1. In this case, a folder pocket having a device for adjusting the pocket stop is described, in which two endless toothed belts are used by means of whose simultaneous movement, the pocket stop can be displaced within the pocket. In this case, the two toothed belts are each connected to one end of the pocket stop and are moved simultaneously in the same direction via the rotation of an adjusting shaft. However, in the case of this device, it is disadvantageous that the elasticity of the toothed belt prevents precise adjustment of the position of the pocket stop, in particular when the toothed belt is no longer able to ensure rigid guidance of the pocket stop under load or after relatively long use.

Published, Non-Prosecuted German Patent DD 287 012 A5 discloses a folder pocket having a device for adjusting the position of the pocket stop. In this case, it is proposed to provide, on both sides of the pocket stop, a cable and an associated cable pulling shaft, which can be moved independently of each other, so that each side of the pocket stop can be positioned independently of the other. In this case, each of the cable pulling shafts is rotated with the aid of an actuating motor, with which an incremental encoder is associated. However, systems of this type have the disadvantage that when cable traction devices are used, slippage cannot reliably be avoided, so that the accurate position of the stop cannot therefore be defined.

Furthermore, Published, Non-Prosecuted German Patent Application DE 27 38 689 A1 discloses a folder pocket having a device for positioning the pocket stop, in which, in order to position the pocket stop, a threaded spindle is provided, which can be set rotating with the aid of a reversible electric motor. The threaded spindle is screwed into a threaded hole at the center of a pocket stop, so that when the threaded spindle is rotated, the pocket stop is moved along the threaded spindle. Although a device of this type permits the adjustment of the position of the pocket stop, the adjustment is exact only along the threaded spindle, and is therefore not ensured at the outer ends of the stop. Furthermore, a defined and intended skewed position of the stop cannot be provided.

### SUMMARY OF THE INVENTION

It is accordingly an object of the invention to provide a folder pocket that overcomes the above-mentioned disadvantages of the prior art devices of this general type, and has an improved device for adjusting the position of the pocket stop, with which a defined skewed position of the stop can be achieved and, even after relatively long use, rigid guidance of the pocket stop is ensured.

With the foregoing and other objects in view there is provided, in accordance with the invention, a folder pocket. The folder pocket contains a pocket stop disposed substantially transversely with respect to a paper running direction and has a first side and a second side. A drive unit is provided for adjusting a position of the pocket stop. A first threaded spindle is connected to the first side of the pocket stop and guides the pocket stop rigidly. The first threaded spindle is connected to the drive unit which can produce a rotational movement of the first threaded spindle. A second threaded spindle is connected to the second side of the pocket stop and guides the pocket stop rigidly. The first threaded spindle and the second threaded spindle are coupled to each other such that a coordinated movement of the first side and the second side of the pocket stop is possible.

The two threaded spindles which are located opposite each other in relation to the center of the stop, are each preferably connected to the respective ends of the pocket stop, and ensure rigid guidance of the pocket stop on both sides, so that an undesired skewed position and inaccurate positioning of the pocket stop are avoided. The coupling additionally provided between the two threaded spindles ensures the possibility of simultaneous and mutually coordinated movement of both sides of the pocket stop. The movement can take place in or counter to the incoming direction of the paper, depending on the direction of rotation of the motor. The coupling of the two threaded spindles can be configured to be mechanical, the motor of the first threaded spindle being connected via a drive element to the second threaded spindle, so that the motor of the first threaded spindle drives both the first threaded spindle and the second threaded spindle.

In addition to the mechanical coupling, it is also possible to connect the two threaded spindles to each other electrically and, in this case, to provide a motor, in particular a servo motor, individually on each of the threaded spindles. In this case, the two motors are coupled via an electric or electronic control unit, so that a simultaneous, coordinated movement of the two spindles and therefore of both ends of the pocket stop is made possible. With the aid of the controller, both motors can be driven in such a way that a simultaneous movement of the pocket stop in or counter to the paper running direction can take place. In addition, the motors can also be driven, via the control unit, in such a way that they cause an opposite movement of the spindles, so that a defined skewed position of the pocket stop is achieved. For the same purpose, the control unit also permits the standstill of one motor during the simultaneous movement of the other motor. Finally, the skewed position of the pocket stop can also be achieved by moving the spindles in the same direction but at a different speed. This movement is likewise achieved by coupling the two motors via the control unit, the control unit controlling the relative movement of the motors in relation to each other.

In accordance with an added feature of the invention, a further drive unit is connected to the second threaded spindle, the further drive unit and the drive unit each have a motorized adjusting device. An electrical control unit couples the first threaded spindle and the second threaded spindle to each other so that a coordination of movement of the first side and the second side of the pocket stop is carried out through electric control of the motorized adjusting device.

In accordance with an additional feature of the invention, the motorized adjusting device is a stepping motor.

In accordance with a further feature of the invention, at least one of the drive unit and the further drive unit has a rotary encoder.

In accordance with a further added feature of the invention, the rotary encoder is a hollow-shaft rotary encoder.

In accordance with a further additional feature of the invention, the electrical control unit is coupled to the motorized adjusting device of the control unit and to the motorized adjusting device of the further control unit in such a way that the motorized adjusting device of the drive unit can be driven in an opposite direction than the motorized adjusting device of the further drive unit. In this manner, the pocket stop can be rotated about a point which is located in a center between connecting points of the first threaded spindled and the second threaded spindle along the pocket stop.

In accordance with another further feature of the invention, the motorized adjusting device is coupled to the electrical control unit in such a way that a skewed position of the pocket stop can be achieved by one of the motorized adjusting devices being driven in such a way that it stands still while another of the motorized adjusting devices is driven in such a way that it moves.

In accordance with another added feature of the invention, a first connection connecting the first threaded spindle to the pocket stop and a second connection connecting the second threaded spindle and the pocket stop are provided. The first connection and the second connection each form a connection that is configured to be articulated and play-free.

In accordance with another additional feature of the invention, the first threaded spindled and the second threaded spindle each has a measuring element that can register an exact position of the pocket stop.

In accordance with a feature of the invention, a processing device is connected to the electrical control unit. The processing device receives, displays and processes measured signals from the measuring element.

In accordance with another embodiment of the invention, the processing device is configured such that it can forward signals to the electrical control unit to permit a presetting of the pocket stop in terms of position and angle.

In accordance with a further embodiment of the invention, the electrical control unit is configured such that in order to position the pocket stop, the electrical control unit can drive one or both of the motorized adjusting devices.

In accordance with an added feature of the invention, a drive element connects the first threaded spindle to the second threaded spindle. The drive element is driven by the drive unit connected to the first threaded spindle.

In accordance with an additional feature of the invention, the drive element is a toothed belt.

In accordance with another feature of the invention, the second threaded spindle has a device for uncoupling the second threaded spindle from the drive element.

In accordance with a further feature of the invention, the second threaded spindle can be rotated manually, so that in an uncoupled state, a single-sided movement of the pocket stop, and therefore a skewed position of the pocket stop relative to the paper running direction can be set.

In accordance with another feature of the invention, the motorized adjusting device has a measuring element for registering an exact position of the pocket stop.

In accordance with a concomitant feature of the invention, the processing device is selected from the group consisting of microcontrollers and PLCs.

Other features which are considered as characteristic for the invention are set forth in the appended claims.

Although the invention is illustrated and described herein as embodied in a folder pocket, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a diagrammatic plan view of an adjusting device for a pocket stop, having two threaded spindles and a motor each, according to the invention; and

FIG. 2 is a plan view of the adjusting device for the pocket stop, having the two threaded spindles, one motor and a mechanical drive element.

### DESCRIPTION OF THE PREFERRED EMBODIMENTS

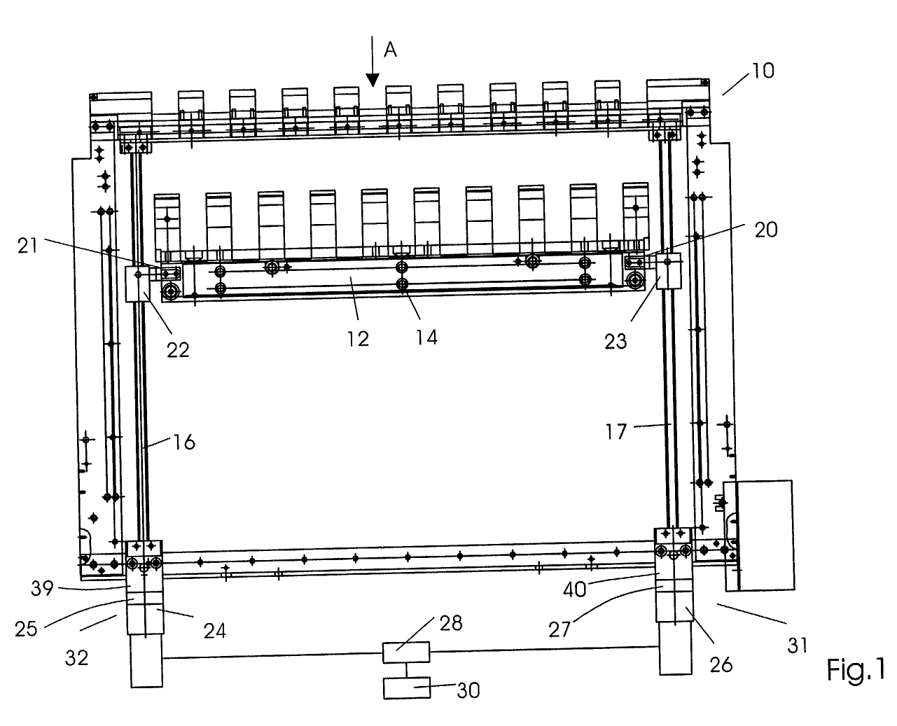

In all the figures of the drawing, sub-features and integral parts that correspond to one another bear the same reference symbol in each case. Referring now to the figures of the drawing in detail and first, particularly, to FIG. 1 thereof, there is shown a folder pocket 10 according to the invention having a pocket stop 12. A folding length of a folded sheet running in a direction A is determined by a position of the folder pocket stop 12 within the pocket 10. Accordingly, in order to adjust the folding length, the folder pocket stop 12 is positioned within the folder pocket 10. For this purpose, threaded spindles 16, 17 are disposed symmetrically with respect to a center 14 of the folder pocket and coupled to the latter. Although the coupling would intrinsically be possible by connecting the threaded spindles 16, 17 via the folder pocket stop 12, this would limit the width of the sheet that could be folded. It is therefore advantageous, as shown in FIG. 1, for the threaded spindles 16, 17 each to be coupled to an outer edge 20, 21 of the pocket stop 12. The threaded spindles 16, 17 are advantageously connected to the pocket stop 12 via spindle nuts 22, 23. The connections between the threaded spindles and the pocket stop 12 are advantageously configured to be articulated and play-free, so that the pocket stop 12 is guided rigidly and without play via the threaded nuts 22, 23 during a movement of the threaded spindles 16, 17.

The movement of the threaded spindles 16, 17 is produced by drive units 31, 32, which can each be set operating independently of each other. The drive units 31, 32 may each have a stepping motor 24, 26 in one embodiment. The stepping motors 24, 26 are coupled directly to the threaded spindles 16, 17 by their drive shafts. It is therefore possible for a number of steps predefined by a controller 28 to the stepping motors 24, 26 to allocate an amount of travel of the spindle nuts 22, 23 and therefore of the pocket stop 12 on each side exactly via the pitch of the threaded spindles 16, 17.

In a further embodiment, the drive units 31, 32 can each have a servo motor 24, 26, a step-up gearbox 25, 27 between the motor output shaft and the threaded spindle 16, 17, and a rotary coder 39, 40, for example an incremental encoder. Via a respective measured signal from the rotary encoders 39, 40, a respective current position of the spindle nuts 22, 23 and therefore of the pocket stop 12 is determined and transmitted to the controller 28. In order to move to a new desired position of the pocket stop 12, the controller 28 determines the respectively necessary direction of rotation of the servo motors 24, 26 and drives the latter until the signals from the rotary encoders report back the fact that the respective desired value has been reached.

If the rotary encoder 39, 40 is installed on the free end of the shaft of the motor, opposite the motor output shaft, the movement of the pocket stop 12 is not registered without error by the measured values from the rotary encoders 39, 40, because of the gear play present in the step-up gearboxes 25, 27. In the case of the close folding tolerances to be complied with on folding sheets, such a dimensional deviation is to be avoided. The rotary encoder 39, 40 is therefore preferably disposed, as a hollow-shaft rotary encoder, on the shaft on the output side of the step-up gearbox 25, 27. This advantageous configuration permits the gearbox output shaft to be coupled directly to the respective end of the threaded shaft 16, 17 as well. The measured value from the rotary encoder 39, 40 therefore always represents the rotational position of the threaded spindles 16, 17 exactly, and therefore the position of the pocket stop 12.

The direction of rotation of the two motors 24, 26 is reversible, so that the threaded spindles 16, 17 can each be set moving in the clockwise and the counterclockwise direction, and accordingly the stop 12 can be moved in the paper incoming direction, that is to say in the direction of the arrow A, or counter to the paper incoming direction. The first threaded spindle 16 is connected via the first motor 24 to the second threaded spindle 17 via the second motor 26, the connection between the motors 24, 26 being provided via the control unit 28. The control unit 28 is capable of controlling the two motors in a manner coordinated with each other in such a way that a mutually coordinated movement of the first and second sides of the pocket stop 12 is made possible via a mutually coordinated movement of the first threaded spindle 16 and the second threaded spindle 17. In this case, the control unit 28 is capable of causing a simultaneous movement of the motor 24, 26 in the same direction, that is to say, therefore, on both sides in or on both sides counter to the paper incoming direction A. Therefore, the paper stop 12 on both sides is accordingly adjusted in or counter to the paper incoming direction, so that the desired folding length is adjusted. However, this assumes that the control unit 28 also balances the speed of rotation of the two motors 24, 26 with each other in such a way that a movement by the same amount takes place on both sides of the stop 12.

In practice, however, from time to time it occurs that the products to be folded have a certain amount of skew on their incoming edge, which can be corrected with the aid of the folder pocket and, in particular, by positioning the folder pocket stop 12. To this end, it is again necessary for a skewed position of the folder pocket stop 12 relative to a vertical connection between the two threaded spindles to be made possible. In the example of FIG. 1, this can be achieved, for example, by the control device 28 controlling the motors 24, 26 in a mutually coordinated manner such that the desired skewed position of the pocket stop 12 is achieved. For this purpose, there are again different possibilities. For example, the control device 28 can control the motors 24, 26 in such a way that the two motors act with different rotational speeds on the threaded spindles 16, 17, so that, for example, the threaded spindle 16 is rotated less often per unit time than the threaded spindle 17. If both threaded spindles 16, 17 are rotated in the same direction, this results in the spindle nut 22 being moved more slowly than the spindle nut 23, and the spindle nut 23 correspondingly covering a greater distance in the same unit time. This procedure achieves the situation where the pocket stop 12 is set skew; it proves again to be particularly advantageous for the threaded spindle nuts 22, 23 to be connected to the outer edges 20, 21 of the folder pocket stop 12 in an articulated and play-free manner.

A skewed position of the pocket stop 12 is additionally possible as a result of the control unit 28 acting on the motors 24, 26 in such a way that, given the same speed of rotation, opposite rotation of the spindles 16, 17 is brought about, so that the pocket stop 12 is rotated about the virtual center 14. This in turn has the advantage that it is possible to dispense with any change to the length adjustment if an additional slight skewed position of the pocket stop 12 has to be adjusted in order to compensate for an edge running skewed on the incoming product to be folded.

In a further embodiment relating to the skewed position of the pocket stop 12, the control device 28 causes a rotational movement of the pocket stop 12 by both motors 24, 26 initially being driven such that the spindles 16, 17 rotate to the same extent in the same direction, in order to achieve a parallel basic adjustment at the correct folding length. Any possibly skewed edge of the incoming paper sheet can then be corrected by one of the motors 24, 26 subsequently being driven by the control unit 28 and rotating in or counter to the paper running direction, while the other motor receives a control signal from the control unit 28 which does not cause any rotational movement of the motor.

For the initial adjustment of the folder pocket stop 12 in the folder pocket 10, a so-called reference excursion can be made.

In a further embodiment of the invention, in addition to the units described hitherto, an additional processing unit 30 can also be provided, which is connected to the control unit 28. The processing unit 30 permits the presetting of the pocket stop 12 in accordance with the desired position or desired angle, and also the processing of sensor signals which permit exact positioning of the pocket stop 12. The processing unit 30 can be used for the purpose of calculating the adjustment values for a number of pocket stops in one or more folding units and transmitting them to the control unit 28 after the input of a standardized type of fold and of the sheet format via an operating panel. In addition, the processing unit 30 can be used for the purpose of storing adjustment values. These values can be called up again as required and transmitted to the control unit 28.

Given appropriate configuration of the control unit 28, the functions of the processing unit 30 can also be integrated there.

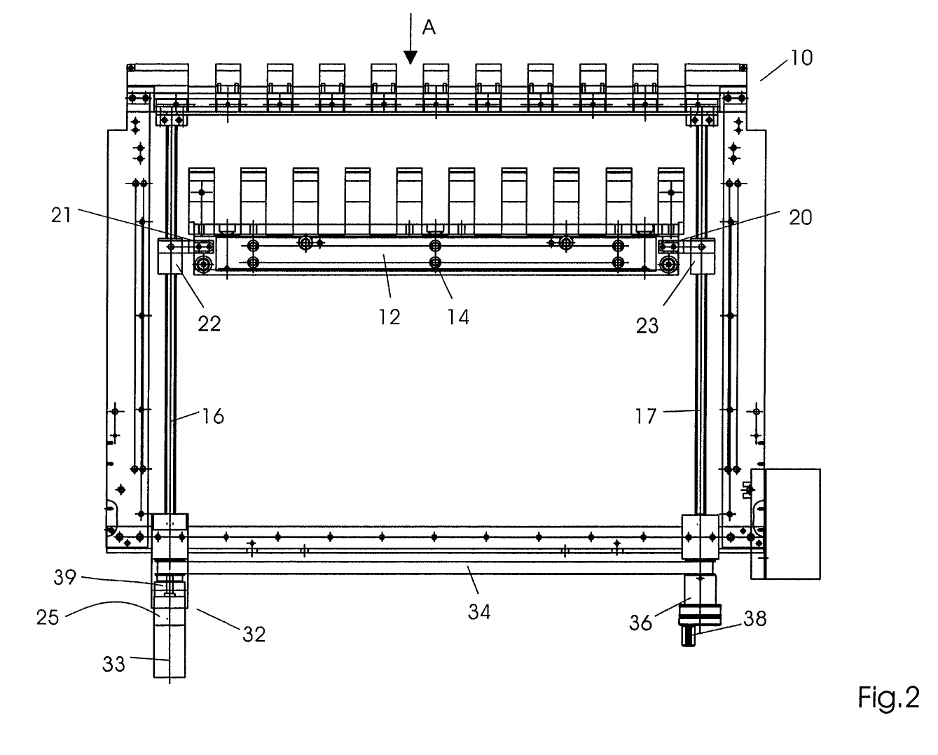

A further embodiment of the folder pocket according to the invention is shown in FIG. 2. Disposed in the folder pocket 10 is the pocket stop 12, which acts in a limiting manner for a folded sheet coming in in the direction of the arrow A and determines the folding length by its position. At its two lateral ends 20, 21, the pocket stop 12 is in each case connected via the spindle nut 22, 23 to the threaded spindles 16, 17 likewise disposed in the folder pocket 10. As already described in connection with FIG. 1, the connection is preferably configured to be articulated and play-free, so that exact positioning of the pocket stop 12 is possible. During a rotation of the threaded spindles 16, 17, the spindle nuts 22, 23 move the pocket stop 12 in or counter to the paper incoming direction A, in accordance with the respective direction of rotation of the threaded spindle.

In the embodiment of the invention shown in FIG. 2, the first threaded spindle 16 is connected to the second threaded spindle 17 via a toothed belt 34, which is connected to a first drive unit 32 on the first side, that is to say on the side of the first threaded spindle 16. As described in the first embodiment, the drive unit 32 can contain either a stepping motor 33 or a configuration of the servo motor, the step-up gearbox and hollow-shaft rotary encoder. The functions of the first drive unit 32 in the aforementioned embodiments are in principle identical in the embodiment of FIG. 2 to that already described in relation to FIG. 1 in embodiment 1. The second side of the toothed belt 34 is connected to a second drive unit 36 of the second threaded spindle 17. However, the second drive unit 36 does not have its own motor. Instead, the drive to the second threaded spindle 17 is provided via the toothed belt 34 which is driven at the first drive unit 32 and therefore also transmits the rotational movement to the second drive unit 36. This mechanical coupling of the two threaded spindles 16, 17 then makes it possible to carry out a mutually coordinated movement of the threaded spindles, since the threaded spindles 16, 17 are coupled to each other mechanically in such a way that the motor 33 of the first drive unit 32 can drive both the first threaded spindle 16 and the second threaded spindle 17.

From the configuration shown, it can clearly be seen that the movement of the threaded spindles 16, 17 in each case runs in a mutually coordinated manner in the same direction, that is to say, therefore, in the paper incoming direction A or counter to the paper incoming direction A. If, then, a skewed position of the pocket stop 12 is desired or necessary, in the present example according to the invention, this can be achieved by the two threaded spindles 16, 17 being uncoupled from each other for the time of the skewed position. This can be done, for example, by a clamping screw 38 which is present in the drive unit 36 of the second threaded spindle 17 being loosened. Loosening the clamping screw 38 has the effect that the first threaded spindle 16 is uncoupled mechanically from the second threaded spindle 17 and, that an outer ring fitted to the second drive unit 36 can be rotated. The outer ring is connected directly to the spindle shaft of the second spindle 17, so that a rotation of the outer ring is transmitted directly to the spindle. A skewed position of the pocket stop 12 can therefore be achieved by rotating the outer ring. Following the adjustment of the desired skewed position, the clamping screw 38 is tightened again, so that during the folding operation, the pocket stop 12 cannot be adjusted further. Using this fixing, the pocket stop 12 is able to maintain its position exactly via the two threaded spindles.

The folder pocket 10 proposed improves precise guidance and permits exact adjustment of a predefined position and a desired skewed position of the pocket stop 12. Furthermore, operational reliability with regard to wear is considerably increased, since the threaded spindles are able to provide more resistance for the folded sheets coming in at high speed than, for example, the toothed belts used hitherto.

We claim:

1. A folder pocket, comprising:
a pocket stop disposed substantially transversely with respect to a paper running direction and having a first side and a second side;
a drive unit for adjusting a position of said pocket stop;
a first threaded spindle connected to said first side of said pocket stop and guides said pocket stop rigidly, said first threaded spindle connected to said drive unit which can produce a rotational movement of said first threaded spindle; and
a second threaded spindle connected to said second side of said pocket stop and guides said pocket stop rigidly, said first threaded spindle and said second threaded spindle coupled to each other such that a coordinated movement of said first side and said second side of said pocket stop is possible.

2. The folder pocket according to claim 1, including:
a further drive unit connected to said second threaded spindle, said further drive unit and said drive unit each have a motorized adjusting device; and
an electrical control unit coupling said first threaded spindle and said second threaded spindle to each other so that a coordination of movement of said first side and said second side of said pocket stop is carried out through electric control of said motorized adjusting device.

3. The folder pocket according to claim 2, wherein said motorized adjusting device is a motor.

4. The folder pocket according to claim 2, wherein said motorized adjusting device is a servo motor.

5. The folder pocket as claimed in claim 2, wherein said motorized adjusting device is a stepping motor.

6. The folder pocket according to claim 4, wherein at least one of said drive unit and said further drive unit has a rotary encoder.

7. The folder pocket according to claim 6, wherein said rotary encoder is a hollow-shaft rotary encoder.

8. The folder pocket according to claim 2, wherein said electrical control unit is coupled to said motorized adjusting device of said control unit and to said motorized adjusting device of said further control unit in such a way that said motorized adjusting device of said drive unit can be driven in an opposite direction than said motorized adjusting device of said further drive unit, so that said pocket stop can be rotated about a point which is located in a center between connecting points of said first threaded spindled and said second threaded spindle along said pocket stop.

9. The folder pocket according to claim 8, wherein said motorized adjusting device is coupled to said electrical control unit in such a way that a skewed position of said pocket stop can be achieved by one of said motorized adjusting devices being driven in such a way that it stands still while another of said motorized adjusting devices is driven in such a way that it moves.

10. The folder pocket according to claim 8, including a first connection connecting said first threaded spindle to said pocket stop and a second connection connecting said second threaded spindle and said pocket stop, said first connection and said second connection each forming a connection that is configured to be articulated and play-free.

11. The folder pocket according to claim 10, wherein said first threaded spindled and said second threaded spindle each has a measuring element which can register an exact position of said pocket stop.

12. The folder pocket according to claim 11, including a processing device connected to said electrical control unit, said processing device receiving, displaying and processing measured signals from said measuring element.

13. The folder pocket according to claim 12, wherein said processing device is configured such that it can forward signals to said electrical control unit to permit a presetting of said pocket stop in terms of position and angle.

14. The folder pocket according to claim 8, wherein said electrical control unit is configured such that in order to position said pocket stop, said electrical control unit can drive one or both of said motorized adjusting devices.

15. The folder pocket according to claim 1, including a drive element connecting said first threaded spindle to said second threaded spindle, said drive element is driven by said drive unit connected to said first threaded spindle.

16. The folder pocket according to claim 15, wherein said drive element is a toothed belt.

17. The folder pocket according to claim 15, wherein said second threaded spindle has a device for uncoupling said second threaded spindle from said drive element.

18. The folder pocket according to claim 17, wherein said second threaded spindle can be rotated manually, so that in an uncoupled state, a single-sided movement of said pocket stop, and therefore a skewed position of said pocket stop relative to the paper running direction can be set.

19. The folder pocket according to claim 10, wherein said motorized adjusting device has a measuring element for registering an exact position of said pocket stop.

20. The folder pocket according to claim 12, wherein said processing device is selected from the group consisting of microcontrollers and PLCs.
